(19) United States
(12) Patent Application Publication
(10) Pub. No.: US 2020/0320449 A1
(43) Pub. Date: Oct. 8, 2020

(54) Methods and Systems for Certification, Analysis, and Valuation of Music Catalogs

(71) Applicant: Rylti, LLC, Woodbury, NY (US)

(72) Inventors: Peter FIORILLO, Babylon, NY (US); Joseph Glick, Waterbury, CT (US); Lawrence R. Baisch, Okemos, MI (US)

(21) Appl. No.: 16/600,376

(22) Filed: Oct. 11, 2019

Related U.S. Application Data
(60) Provisional application No. 62/829,151, filed on Apr. 4, 2019.

(51) Int. Cl. G06Q 10/06; G06F 9/451; G06N 3/08

(52) U.S. Cl. CPC G06Q 10/0631; G06Q 2220/18; G06N 3/08; G06F 9/451

(57) ABSTRACT

A process for automatically certifying royalty and license fees in the music industry includes obtaining non-standardized exploitation data associated with a plurality of media items from a first plurality of data sources during a predetermined period of time, wherein the exploitation data is provided in a plurality of formats, applying a standardization schema to the non-standardized exploitation data to obtain standardized exploitation data, obtaining royalty data from a second plurality of data sources, wherein the royalty data comprises royalty parameters associated with one or more entities associated with the plurality of media items; and determining an entity-specific royalty data for the one or more entities based on the standardized exploitation data and the royalty data.

### CROSS REFERENCE TO RELATED APPLICATIONS

This application claims the benefit of U.S. Provisional Application No. 62/829,151, filed on Apr. 4, 2019, the entire contents of which are hereby incorporated by reference.

This application is related to U.S. Application No. 16/555,611, filed on Aug. 29, 2019, which claims the benefit of U.S. Provisional Application No. 62/769,024, filed on Nov. 19, 2018.

### FIELD OF THE INVENTION

Embodiments described herein generally relate to audit, certification, analysis, and valuation of music catalogues.

### BACKGROUND

The music industry is highly complex with multiple licenses and royalty owners. Recent legislation supports the need to help obtain better and more timely payment of license and royalty fees. Each entity that is part of the industry is concerned about cost, timing and accuracy, which affects retaining/losing talent & customers, and maximizing income from leased or owned licenses. Currently, the data reported from various entities is inconsistent, increasing the likelihood and costs of audits, and tying up massive staff and financial resources. The increased consumption of music via Digital Service Providers (DSPs) has shifted the industry to more digitally focused royalty payments.

Currently, royalties are generated by sales transactions of musical works. First, exploitation data (i.e., data reflecting sales or transactions of a work) is captured. Such exploitation data may be generated, for example, in response to the purchase of a physical compact disc (“CD”) or album, or digital download of a song or an album (for example from iTunes store or Google Play). The work may be exploited by being consumed over a streaming service. The exploitation initiates a need to pay the rights holder an appropriate royalty. The rights holders could be the party who wrote the song, recorded the song, etc. The rights according to ownership is captured in a contractual relationship between the rights holder and the parties involved with the first half of the transaction sale. However, due to the numerous data sources and inconsistent data formats, calculating royalty payments has been very complicated, manual, and fraught with errors. Auditing the rapidly growing data from music streaming services has been an elusive challenge for the industry because of the data volume and challenges to access it. Typically, sample data is audited, and findings are extrapolated such that a royalty payment is determined through negotiation.

When a royalty audit begins, the initial data received by the auditor is from the client (e.g., a licensor), while the data from the auditee (e.g., licensee) is often received much later than the transactions covered by the data. Typically, the auditor's first deliverable to the client is a preliminary report with initial findings that may indicate the potential scope of findings in the completed audit.

Further, the participants in the current music industry face lack of transparency, accuracy and predictability regarding the true value of musical works and the catalogs they comprise. There are inconsistent, unreliable and dynamic business processes and data driving this problem. Clarity regarding the value of musical works is becoming even more difficult with the rise of digital distribution of works.

### BRIEF DESCRIPTION OF DRAWINGS

FIG. 1 is a system diagram illustrating a distributed system for an enhanced auditing and valuation platform for the music industry, according to one or more embodiments.

FIG. 2 is a diagram illustrating a flow diagram for automatically generating royalty data using a machine learning platform, according to one or more embodiments.

FIG. 3 is a diagram illustrating a flow diagram for improving a machine learning-enabled platform for enhanced audit and valuation of media items for the music industry, according to one or more embodiments.

FIG. 4 is a diagram illustrating a flow diagram for providing a sample royalty audit for the music industry based on incomplete data, according to one or more embodiments.

FIG. 5 is a diagram illustrating a flow diagram for utilizing a user interface to request and obtain valuation data for the music industry, according to one or more embodiments.

### DESCRIPTION OF EMBODIMENTS

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of entity resolution having the benefit of this disclosure.

As used herein, the term “computer system” can refer to a single programmable device or a plurality of programmable devices working together to perform the function described as being performed on or by the computer system.

As used herein, the term “medium” refers to a single physical medium or a plurality of media that together store what is described as being stored on the medium.

As used herein, the term “network device” can refer to any programmable device that is capable of communicating with another programmable device across any type of network.

Generally, data related to the music industry may be presented in myriad forms for purposes of royalty audits. Many different parties have unique schemas for providing auditors data. Further the data received from the various parties may be skewed or incomplete. As an example, the data may not include every party related to a particular record. For example, a particular recording of a particular song may be associated with an artist specific to that recording. Further, because the music-related data set may be in a unique format, time and resources are consumed in manually parsing data to be able to determine what data is presented in the set

Embodiments described herein are directed to a platform that utilizes artificial intelligence and machine learning to regularize data received in inconsistent formats to identify normalized royalty parameters through entity resolution, and provide a global industry data model for the music industry to more efficiently and more completely identify all parties to which royalties are owed. With respect to the normalized royalty parameters, data may be obtained from numerous data sources, such as a data bank of royalty agreements from entities within the music industry, or auditing records prepared for and/or provided by auditors. The various records may be used to train a machine learning model, such as a decision tree, a neural network, or any other type of machine learning model, to categorize various royalty-related data into normalized royalty parameters.

Further, the platform allows for the ingestion of extremely large amounts of data, preferably all or substantially all of the data relevant to an informal royalty examination or formal royalty audit. By direct contrast, current solutions for royalty exams or audits rely on a sampling of data. The data may be obtained from various sources, such as digital service provider (“DSP”) streaming logs, DSP sales files, royalty payment statements, rights holder works catalogs, and royalty rates and ownership share data. The platform may parse and process the data into a standardized useful format for processing, handle errors in the data (such as missing data, formatting errors, or other human or machine created errors), execute complete audit testing such that human input is not necessary, or is only necessary for interpretive tasks, such as analyzing testing or analytical output.

The platform may also provide secure, compliant with regulatory required provisions, browser-based access to auditors, rights holders, DSPs, music companies, professional agencies and associations, and other entities, such as the Music Licensing Collective.

In one or more embodiments, the platform may provide automated certification of the receipt of machine readable, royalty-related data. That is, the platform may read in exploitation data (i.e., sales data, streaming data, and other data related to media consumption) from multiple sources. The data may be read in via multiple data feeds or streams that are not standardized (i.e., metadata fields and/or data entries are not consistent across the exploitation data, despite referring to the same thing). That is, the various sources of the exploitation data may provide the data in different formats. For example, some exploitation data may include a metadata field for “song” whose data entry is “Hotel California,” whereas other exploitation data may include a metadata field for “work” whose data entry is “hotel_california,” with both sets of exploitation data referring to the same thing.

Similarly, royalty information (i.e., royalty payment statements between various entities) may be imported from multiple sources in multiple formats. Data may be obtained from numerous resources to develop an industry model, such as records from digital service providers (“DSPs”), record contracts, sales data, agreements between distributors, record producers, streaming services, retailers, and the like.

The platform may read in the data on a periodic basis and determine royalty payments, for example on a monthly basis using an artificial intelligence-enabled module. Thus, the resulting royalty payments due may be determined prior to actual payments being made such that an after-the-fact audit is no longer necessary,

In one or more embodiments, the results may be reviewed by a professional in a user interface and/or approved by providing a certification of accuracy of the royalty payments due or referring them back to the payer for correction or adjustment.

In one or more embodiments, the platform may be used to process outlier data from royalty audit tests to enable discovery of insights. The artificial intelligence-enabled platform relies on a neural architecture that maps data in various structures to an abstracted music industry ontology not only by concept definitions but also by relevance of data sets and values to royalty audit tests

The platform runs relevant scenarios (e.g., combinations of process methods and calculations that are dynamically assembled based on user input and/or systematic choices) and outputs those that produce significant results. Discovery results are considered significant if they 1) meet criteria provided during user input, such as volume or revenue thresholds, 2) provide evidence relative to a theory the user is testing, such as underreporting or operational inefficiency, or 3) identify new relevant parameters or refine operand values for analytics methods. The remaining data may be considered “outlier” data.

In one or more embodiments, the potential outcomes for the outlier data may be determined and presented in a user interface to allow further interpretation and analysis by an expert user. Based on the user response, the ontology (e.g., an abstract concepts mapped to arrays of potentially relevant qualitative and quantitative properties, the actual relevance of which is computed for each scenario to drive the appropriate classifications, methods and values for the computation) may be modified to capture the confirmed relationships based on the accepted potential outcome, such that the neural architecture may better handle the outlier data in future processes when the questioned relationship arises again.

In one or more embodiments, the platform may also be utilized to enable preliminary royalty audit findings using incomplete information, and also may be used for valuation. That is, the platform can provide insight into market performance of a given work, recording, or performance, delivering visibility into the historical, current, and projected values of works and catalogs.

The process results in far more accurate and timely insight into sales performance, across multiple dimensions (e.g., time, geography, market segments, retailers, etc.), in order to improve catalog/works ownership and management decisions. The process also provides a solution to the technical problem of providing accurate calculations based on incomplete records received from various sources. By applying a global music industry model, unidentified entities may be identified based on relationships determined by the model in real time, which was not possible without the use of a global neural network model. In addition, the use of a neural network allows for the prediction and identification of relationships that may not be apparent to a user without the model due to deep learning technology.

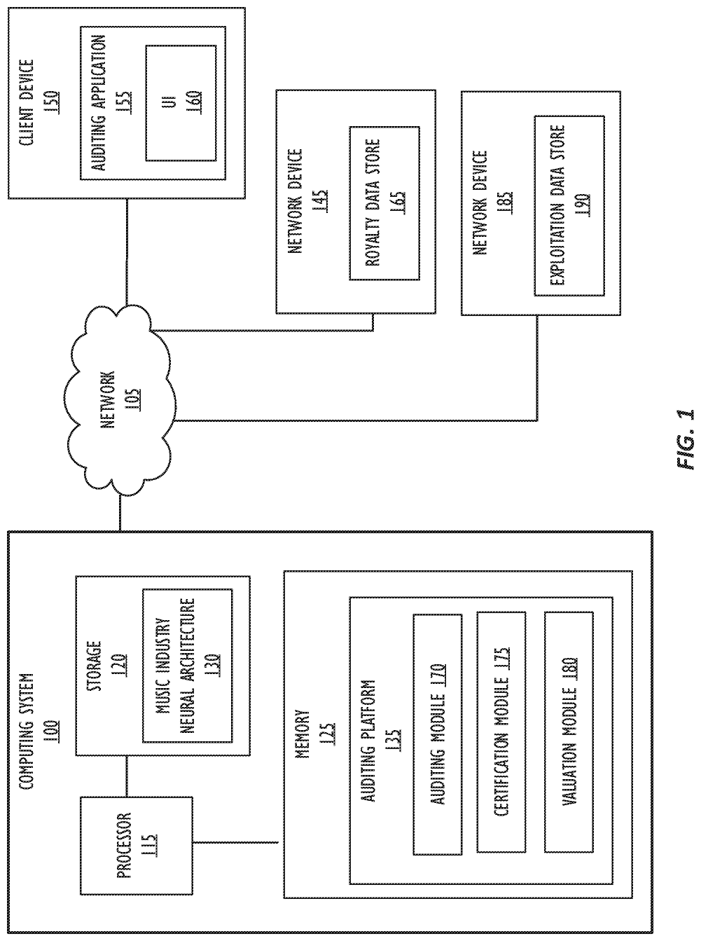

Turning to FIG. 1 a system diagram is presented illustrating a distributed system for an enhanced auditing platform for the music industry, according to one or more embodiments. FIG. 1 includes a computing system 100 on which the platform is hosted, connected to one or more network devices 145 and other devices such as client device 150 across a network 105. Computing system 100 may be, for example, one or more server devices or other computing devices. Further, computing system 100 may be a distributed network system, such as a network cloud, across which the various components and functionality described within computing system 100 are distributed. Network device 145 may include any kind of device accessible across network 105, with which computing system 100 may communicate, and which may provide relevant royalty data, such as from royalty data store 160. For example, network device 145 may be an additional computing system, a server, a remote computer, or the like. Further, network device 145 may be controlled by the same or different entity as computing system 100 and/or auditor client device 150. Network 105 may include many different types of computer networks available today, such as the Internet, a corporate network, a Local Area Network (LAN), or a personal network, such as those over a Bluetooth connection. Each of these networks can contain wired or wireless programmable devices and operate using any number of network protocols (e.g., TCP/IP). Network 105 may be connected to gateways and routers, servers, and end user computers.

According to one or more embodiments, computing system 100 may include, for example, a storage 120, a memory 125 and processor 115. Processor 115 may include a single processor or multiple processors. Further, in one or more embodiment, processor 115 may include different kinds of processors, such as a central processing unit (“CPU”) and a graphics processing unit (“GPU”). Memory 125 may include a number of software or firmware modules executable by processor 115. Memory 125 may include a single memory device or multiple memory devices. As depicted, memory 125 may include an auditing platform 135. The auditing platform 135 may be a process automation platform that provides automated services for audit, verification, and royalty and license fees in the music industry. In addition, auditing platform 135 may provide a platform-as-a-service (“PaaS”) related to valuation and auditing in the music industry. Memory 125 may be operatively coupled to processing element 115. Memory 125 may be a non-transitory medium configured to store various types of data. For example, memory 125 may include one or more memory devices that comprise a non-volatile storage device and/or volatile memory. Volatile memory, such as random access memory (RAM), can be any suitable non-permanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated RAM is not large enough to hold all working data. The non-volatile storage device may also be used to store programs that are loaded into the RAM when such programs are selected for execution. As described above, the royalty auditing platform 135 may utilize a global industry data model 130, which may be stored in storage 120. Storage 120 may include a single storage device, or multiple storage devices.

Persons of ordinary skill in the art are aware that software programs may be developed, encoded, and compiled in a variety of computing languages for a variety of software platforms and/or operating systems and subsequently loaded and executed by processing element 115. In one embodiment, the compiling process of the software program may transform program code written in a programming language to another computer language such that the processing element 115 is able to execute the programming code. For example, the compiling process of the software program may generate an executable program that provides encoded instructions (e.g., machine code instructions) for processor 115 to accomplish specific, non-generic, particular computing functions.

After the compiling process, the encoded instructions may then be loaded as computer executable instructions or process steps to processing element 115 from storage (e.g., memory 125) and/or embedded within the processing element 115 (e.g., cache). Processing element 115 can execute the stored instructions or process steps in order to perform instructions or process steps to transform the computing device into a non-generic, particular, specially programmed machine or apparatus. Stored data, e.g., data stored by a storage device, can be accessed by processing element 115 during the execution of computer executable instructions or process steps to instruct one or more components within the computing system 100.

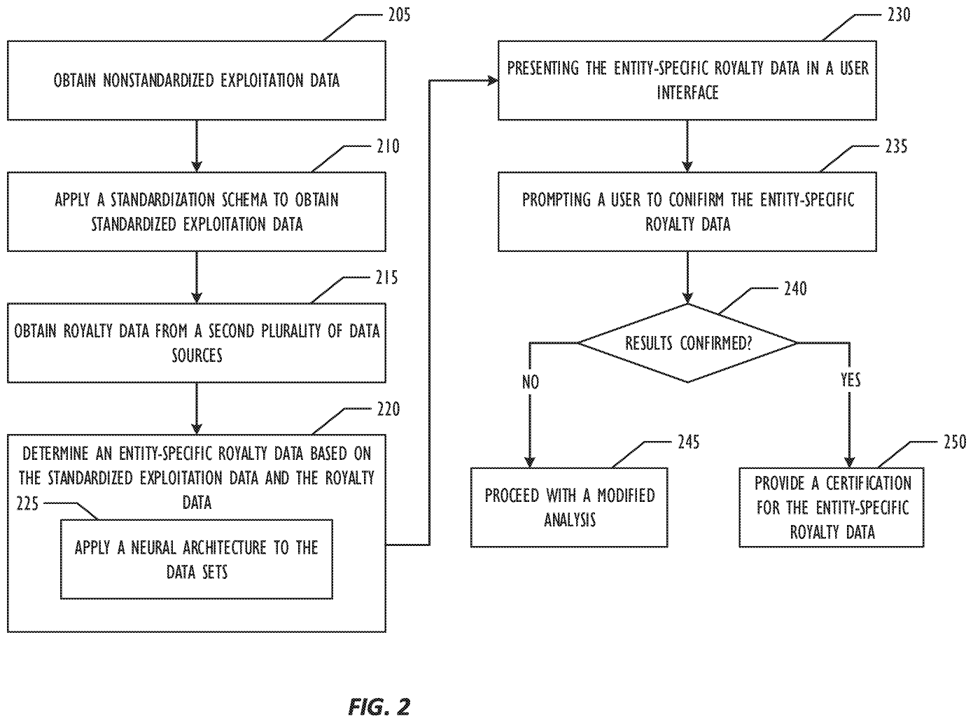

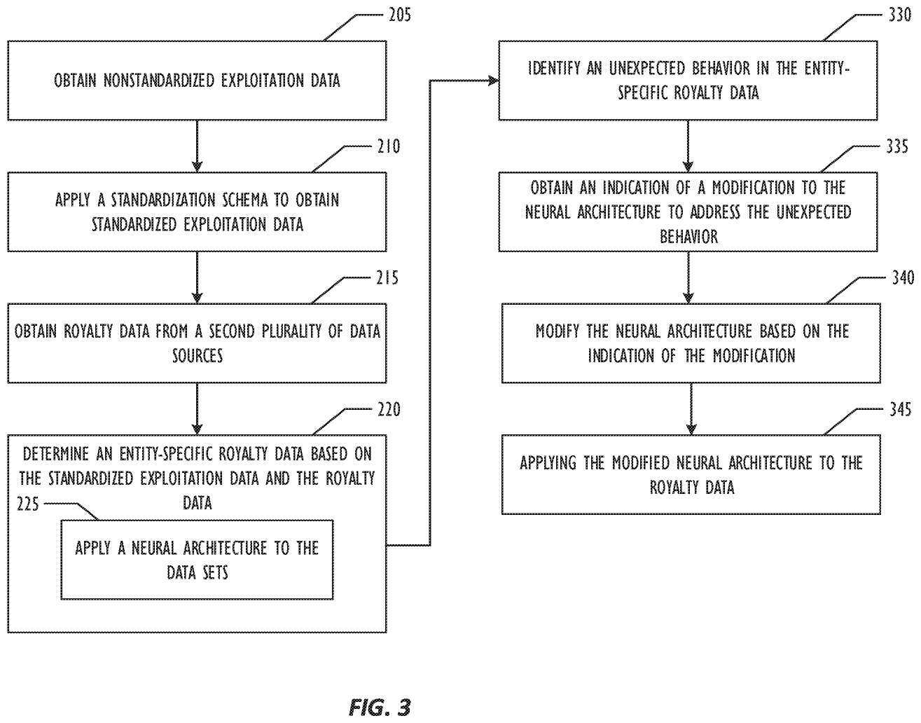

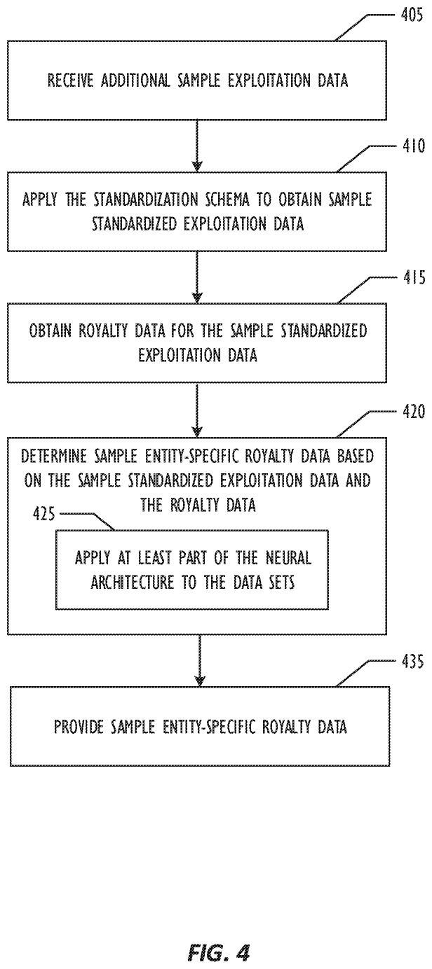

As a PaaS format, the auditing platform 135 may include multiple functional modules, which may be provided to clients (e.g., client device 150) in any combination. The auditing platform 135 may include an auditing module 170, a certification module 175, and valuation module 180. The auditing module 170 may utilize artificial intelligence, for example in the form of music industry neural architecture 130 to enable royalty audit findings using whole information or incomplete information, as will be described below with respect to FIGS. 3-4. The certification module 175 may enable continuous analysis and certification of royalties payable from service providers and other processors to music rights-holders, as will be described below in greater detail with respect to FIG. 2. The valuation module 180 may deliver automated, data-driven valuation of musical works and the relevant performance analytics for music catalogs and the works they contain.

The auditing platform 135 may perform royalty calculations from data received from multiple sources. For example, the auditing platform 135 may obtain royalty data 165 from entities such as rights holders, via network device 145. Although only a single network device is presented, it should be understood that the royalty data could be obtained from royalty data stores from multiple sources. In addition, the auditing platform 135 may obtain exploitation data 190 from an exploitation data store 190 from network device 185, which may contain data from entities such as DSPs, media sales entities, and the like. Although only a single network device is presented, it should be understood that the exploitation data could be obtained from exploitation data stores from multiple sources.

The auditing platform 135 may be made available to various entities, such as auditors, licensors, licensees, and other entities involved in the music industry ecosystem, for example through client device 150. In one or more embodiments, auditing application 155 may provide some or all of the functionality as described below with respect to FIGS. 2-5. Further, auditing application 155 may provide an interface such that a user of client device 150 may utilize the various components and functionality of computing system 100. A user interface can include a display, positional input device (such as a mouse, touchpad, touchscreen, or the like), keyboard, or other forms of user input and output devices. When the output device is or includes a display, the display can be implemented in various ways, including by a liquid crystal display (LCD) or a cathode-ray tube (CRT) or light emitting diode (LED) display, such as an OLED display.

Persons of ordinary skill in the art are aware that the various devices and systems in FIG. 1 may comprise other components well known in the art, such as sensors, powers sources, and/or analog-to-digital converters, not explicitly shown in FIG. 1. Further, the programmable devices depicted in FIG. 1 are a schematic illustration of embodiments of programmable devices which may be utilized to implement various embodiments discussed herein

Turning to FIG. 2, a diagram is depicted illustrating a flow diagram for automatically generating royalty data using a machine learning platform, according to one or more embodiments. The flowchart begins at 205, where the auditing platform 135, for example the auditing module 170 obtains non-standardized exploitation data.

The non-standardized exploitation data may be organized according to one or more non-standardized metadata schemas, according to which metadata field values and/or data entries are not consistent across the exploitation data. For example, some exploitation data may include a metadata field for “song” whose data entry is “Hotel California,” whereas other exploitation data may include a metadata field for “work” whose data entry is “hotel_california,” with both sets of exploitation data referring to the same thing.

As described above, the non-standardized exploitation data may be obtained from exploitation data store 190, across network 105. The exploitation data may be received in numerous, inconsistent formats separate and in addition to the example described herein. The exploitation data includes exploitation information for media items, such as sales data, streaming data, and the like. In one or more embodiments, the exploitation data may be obtained for a particular period of time, for example, for a particular week, month, calendar quarter, year, and the like.

The flowchart continues at 210, where the auditing module 170 applies a standardization schema to generate standardized exploitation data. In one or more embodiments, the standardization schema may include a transformation process that standardizes the exploitation data into a standardized metadata schema.

The standardized metadata schema describes how the metadata of the standardized exploitation data is organized within a standardized exploitation data file. The standardized metadata schema may, for example, include a plurality of metadata fields, such as “song title,” “artist name,” “date played” and the like, which may be associated with appropriate data entries of the standardized exploitation data for a particular exploitation (i.e., an incidence of a work being played or otherwise exploited such that royalties are owed). The standardized metadata schema is preferably comprised of an intersection of field values (or their determined equivalents) from a plurality of different types of non-standardized exploitation data. As discussed above, the plurality of types of non-standardized exploitation data can come from various sources, and may have various different formats (e.g., schemas) depending on the source.

In one or more embodiments, the transformation process may include referring to a set of updateable transformation rules correlating known non-standardized metadata fields with the standardized metadata fields. Some of the variations of field values by diverse entities may be provided via expert users, as described above, to update the ontology (e.g. “configuration” and “product type” in conjunction with additional contextual factors).

In many cases machine learning can be used to derive the appropriate transformation rules (e.g. “song title”=“song”=“title”=“work title”=“track title”, but NOT “album title”) because of the high volume of occurrences of these labels. Accordingly, in one or more embodiments, the transformation process may include automatically parsing and comparatively analyzing metadata fields and/or data entries so as to derive or otherwise update the transformation rules.

For example, in operation, the auditing module may parse the metadata fields “song title” and “work title,” and/or the data entries “Hotel California” and “hotel_california,” and via comparative analysis may determine a confidence value that the metadata fields correspond to the standardized field “song” and that the data entries correspond to the standardized data entry value “Hotel California.”

It will be understood that parsing and analysis may also be undertaken to determine values for empty metadata fields and/or data entries. For example, the auditing module may identify the data entry value of “hotel_california” associated with an empty metadata field, and via comparative analysis determine a confidence value that the empty metadata field value corresponds to the standardized filed “song.”

It will also be understood that while the examples described are limited to two values each for the metadata fields and data entries, the invention contemplates parsing and comparative analysis taking into account all or substantially all of the exploitation data and/or royalty data. Moreover, similar parsing and comparative analysis may be done for other metadata fields and/or data entries.

In addition, it will be understood that known artificial intelligence and machine learning methodologies may be utilized for training the auditing module to perform the automatic parsing and comparative analysis. The specifics of the artificial intelligence training methodologies are not the subject of this invention.

Accordingly, the application of the standardization schema transforms the non-standardized exploitation data, with its non-standard metadata fields and data entries, into the standardized exploitation data, with its standardized metadata fields and data entries. The transformation may involve creating new data files using the standardized schema, and populating the new data files with the data entries of the corresponding non-standardized data according to the transformation rules. The transformation may alternatively involve simply changing the metadata field values and/or data entries to reflect the standardized schema. In some embodiments, not all of the non-standardized metadata fields and/or data entries will be transformed according to the schema. In particular, in some embodiments, only values relevant to the standardization schema will be affected.

In some embodiments, the schema may be one or more of: an underreporting schema, an underpayment schema, and an unmatched schema. The underreporting schema transforms non-standardized data into standardized data such that values relevant to determining underreporting are transformed (i.e., standardized). The underpayment schema transforms non-standardized data into standardized data such that values relevant to determining underpayment are transformed (i.e., standardized). The unmatched schema transforms non-standardized data into standardized data such that values relevant to determining unmatched line items are transformed (i.e., standardized). It will be understood that other custom schema may be utilized in accordance with the type of significant results the system attempts to produce, as discussed below. Moreover, the standardization schema may be selected from among a plurality of stored standardization schema depending on the type of significant results desired.

At 215, the auditing module 170 obtains royalty data from a second plurality of data sources. Royalty data may become from any number of entities within the music royalty ecosystem. For example, licensors, as well as public and private entities that represent licensors, may have royalty data related to the media items. Further, licensees may also have royalty information. The royalty data may include such royalty parameters as royalty rates or other agreed upon commercial terms. The royalty data may also indicate relationships between a particular media item that is the subject of the exploitation data, and rights holders, such as individual performers, writers or other artists, and the like. In one or more embodiments, the royalty data may not be standardized when it is obtained and, thus, the auditing module 170 may perform a standardization process similar to that described above with respect to the exploitation data.

The flowchart continues at 220, where the auditing module 170 determines an entity-specific royalty data based on the standardized exploitation data and the royalty data. That is, the transformed, standardized exploitation may be considered in conjunction with the royalty data in order to determine royalty payments due to various rights holders. Determining the entity-specific royalty data may include applying a neural architecture to the data sets, such as at 225.

The neural architecture may be, for example, music industry neural architecture 130 of FIG. 1. The neural architecture may include a map of data structures to an abstracted music industry otology by relevance of data sets and values to royalty audit tests. The neural architecture allows the audit platform 135 to run all relevant scenarios and output those that produce significant results, as well as potential outcomes for validation for outliers for which no significant results are produced.

Each relevant scenario involves a set of data inputs describing a problem that drives the comparative analysis that the audit platform performs to solve the problem. The problem may be a business problem or a bad data problem, or any other problem that is defined by the user or the auditing module using known artificial intelligence and machine learning methodologies. The comparative analysis may involve determining relationships between node values in the neural architecture. Relevant scenarios may relate to the identification of underpayments, underreporting or un-matched data.

For example, in terms of underpayment scenarios, the comparative analysis may involve several simulations or scenarios for payments in various scenario contexts defined by the data and schema. Using the underpayment example, the number of downloads of a certain song from several sources may be determined for each source. The comparative analysis may reveal, for example, how the number of downloads of the song varies across sources with respect to considerations like, source size, source popularity, source genre preference, source format, etc.

The significant results are those that show consistency among the results. For example, if the vast majority of scenarios have results showing 10,000 downloads within a period of time, significant results will be within a tolerance of 10,000 downloads for the given scenario. The tolerance is preferably dynamic and determined based on the variances in the data between the considered scenarios.

The outlier results are results that are inconsistent with the significant results. In other words, they are outside the tolerance. Continuing with the previous example, if a given source shows 5 downloads then the result is likely outside the tolerance and is an outlier. The outlier thus suggests the song downloads from given source are being underreported, and the outlier scenario is flagged.

In operation, the neural architecture may enable and produce potential simulations and access from storage confirmed simulations which have previously been confirmed by a user. These simulations may inform the comparative analysis, and may be used to resolve the outlier scenarios by reference to similar scenarios that have been resolved via user intervention.

For example, the auditing module 170 may resolve various “bad data” circumstances. These bad data circumstances may include, for example, missing data (e.g., no artist name on an exploitation or no record of an exploitation from a source where one could be expected), corrupted data, misspelled data (e.g., “eegals” vs. “Eagles”), data subject to industry taxonomy diversity (e.g., “song” vs. “work” or “hotel_california” vs. “Hotel California”), and any other circumstances where discrepancies or omissions of the gathered data would, if left unresolved, lead to the propagation of insignificant results, as described herein.

The resolution of these bad data circumstances may be accomplished via parsing and comparative analysis in accordance with the neural architecture and ontology. In addition, it will be understood that known artificial intelligence and machine learning methodologies may be utilized for training the auditing module to perform the automatic parsing and comparative analysis. The artificial intelligence training methodologies are not the subject of this invention.

Further, the neural architecture may contain suppression relationships between node values and outcome types. Suppression relationships are a form of computable context representation that minimize the potential number of false positives. Suppression drivers could be qualitative values, quantitative thresholds or rules that include both. In complex calculations and systemic scenarios multiple paths can lead to the same node value, and some paths may indicate that the node is relevant while others may compute that it is irrelevant. If a suppression driver reaches a predefined threshold, the node value is suppressed from the computation.

As an example, once a run of a royalty unit test is complete, then the resulting data set may be made available via a user interface for viewing and a summary of the results may be displayed or otherwise provided. As another example, once a royalty rate test is run, the resulting data set and the financial totals would be available in the user interface. The entity-specific royalty data includes a calculated royalty audit based on the full data set

At 230, the certification module 175 presents the entity-specific royalty data in a user interface. The entity-specific royalty data may be displayed in a way that is readable to a user through on-screen dashboards or report downloads. At 235, the user is prompted through a Raw Sales user interface to confirm the entity-specific royalty data (e.g. if “configuration”=“product type”). Entity-specific royalty data may include, for example, raw sales or streams, incoming lines with rates applied, catalog works, and applicable payout rates. In one or more embodiments, the user may be prompted to confirm the automatically generated entity-specific royalty data. Alternatively, or additionally, the user may be prompted to select among potential outcomes (e.g., possible relevance or equivalence mappings) determined by the auditing platform for the outlier data based on potential simulations. As an example, for a given catalog work or catalog data set, the unit sales reported may be greater than the units reflected in the royalty payable data set. As another example, for a given catalog work or data set, the specific work appears in the sales data set but not in the royalty payable data set. At 240, a determination is made regarding whether the results are confirmed. If, at 240 the results are not confirmed, then the flowchart continues at 245 and the certification module 175 proceeds with a modified analysis. In one or more embodiments, the modified analysis may proceed based on a suppression of relationships as indicated by the user at 235. Returning to 240, if a determination is made that the results are confirmed, the flowchart continues at 250 and a certification document may be provided for the entity-specific royalty data. According to one or more embodiments, the certification document may be a restricted digital file or data set which is viewable and/or available via a secure connection. As an example, the certification document may be linked to particular security privileges. Additionally, or alternatively, the certification document may be secured using a private key administration module.

FIG. 3 is a diagram illustrating a flow diagram for improving a machine learning-enabled platform for enhanced audit and valuation of media items for the music industry, according to one or more embodiments. The flowchart begins similar to that described in FIG. 2. Specifically, the flowchart begins at 205, where the auditing platform 135, for example the certification module 175 obtains non-standardized exploitation data. The flowchart continues at 210, where the certification module 175 applies a standardization schema to obtain standardized exploitation data. In one or more embodiments, the standardization schema is utilized to normalize differing data sets within a same data class, such as sales data or catalog data. At 215, the certification module 175 obtains royalty data from a second plurality of data sources. The flowchart continues at 220, where the certification module 175 determines an entity-specific royalty data based on the standardized exploitation data and the royalty data. Determining the entity-specific royalty data may include applying a neural architecture to the data sets, such as at a data source type.

The flowchart continues at 330, where the auditing module 175 identifies an unexpected behavior in the entity-specific royalty data. In one or more embodiment, the unexpected behavior may be that the relevant scenarios do not produce significant results, as described above. Then, at 335, an indication of a modification to the neural architecture is obtained to address the unexpected behavior. The modification of the neural network may be determined automatically (e.g., through machine learning), or through user input. For example, the indication of the modification may be determined based on the input from the user interface as described above with respect to 235.

The flowchart continues at 340 and the auditing module 170 modifies the neural architecture based on the indication of the modification. As described above, the neural architecture may be trained to determine various relationships among potential interactions for entities, contractual obligations, and the like in the music industry for various media items. The modification, for example, may enhance certain relationships, suppress certain relationships, add or remove certain relationships, and the like. As such, the neural architecture allows for more complete calculation of fees due by automatically determining missing components of the equation based on incomplete or inaccurate data received from various entities.

The flowchart concludes at 345, where the auditing module 170 applies the modified neural architecture to the royalty data. That is, the transformed, standardized exploitation may be considered in conjunction with the royalty data in order to determine royalty payments due to various rights holders based on the modified neural architecture. Similarly, an additional user may then utilize the modified neural architecture to obtain a more complete determination of royalty payments due, even with similarly incomplete or inaccurate records.

FIG. 4 is a diagram illustrating a flow diagram for providing a sample royalty audit for the music industry based on incomplete data, according to one or more embodiments. The flowchart begins at 405, where the auditing platform 170 may utilize a relevant subset of the exploitation data. As described above, often the first step in undertaking an audit for a client is to perform a preliminary analysis based on incomplete data (e.g., the sample exploitation data). The relevant subset of exploitation data may include a subset of the entire exploitation data, and/or may be processed for a subset of data types for each record to obtain interim results.

The flowchart continues at 410, where the auditing module 170 applies the standardization schema to obtain a relevant subset of standardization exploitation data. As described above, the applying the standardization schema may include a transformation process that standardizes the exploitation data into a standardized schema. At 415, the auditing module 170 obtains royalty data for the relevant subset of standardized exploitation data. In one or more embodiments, the royalty data may be obtained from outside sources, such as royalty data store 165, or may be obtained in the form of the relevant subset of royalty data.

The flowchart continues at 420 where the auditing module 170 determines interim entity-specific royalty data based on the relevant subset of standardized exploitation data and the royalty data. In one or more embodiments, determining the sample entity-specific royalty data includes, at 425, applying at least part of the neural architecture to the data sets. In one or more embodiments, the neural architecture may be an improved neural architecture as described above. In doing so, the auditing module 170 may obtain supplemental royalty information that has been “baked into” the music industry neural architecture (i.e., accurate rights holders associated with a particular media, insight into royalty data previously obtained and incorporated into the music industry neural architecture, and the like). The flowchart concludes at 435 where the auditing module 170 provides interim entity-specific royalty data.

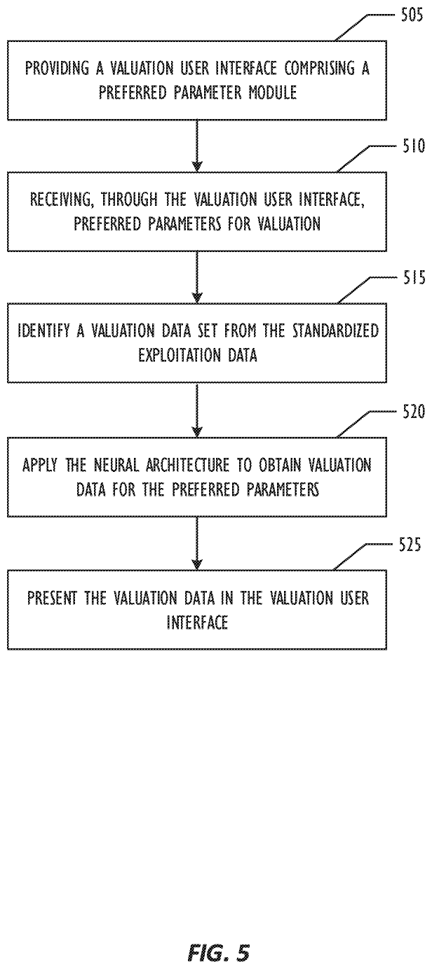

FIG. 5 is a diagram illustrating a flow diagram for utilizing a user interface to request and obtain valuation data for the music industry, according to one or more embodiments. The process can provide insight into market performance for a given work, recording or performance, delivering visibility into the historical, current, and projected values of works and catalogs. The flowchart begins at 505, where the valuation module 180 provides a valuation user interface comprising a preferred parameter module. The preferred parameter module may allow a user to select parameters for which royalty data should be provided. The preferred parameters may indicate a particular media item, artist, or other entity in the music royalty ecosystem, geographical region, time span, and the like. The flowchart continues at 510, where the valuation module 180 receives, via the valuation user interface, preferred parameters for valuation. The valuation user interface may include text boxes by which the user can select parameters, check boxes, pulldown menus, and the like, or a combination thereof.

At 515, the valuation module 180 identifies a valuation data set from the standardized exploitation data. The exploitation data may be reduced, for example, to the particular preferred parameters selected by the user. Then, at 520, the valuation module 180 applies the neural architecture to obtain valuation data for the preferred parameters. In doing so, the valuation module 180 leverages the knowledge assessed in the neural architecture to determine a valuation on the catalog requested by the user. The flowchart concludes at 525, where the valuation module 180 presents the valuation data in the valuation user interface.

It is to be understood that the various components of the flow diagrams described above, could occur in a different order or even concurrently. It should also be understood that various embodiments of the inventions may include all or just some of the components described above. Thus, the flow diagrams are provided for better understanding of the embodiments, but the specific ordering of the components of the flow diagrams are not intended to be limiting unless otherwise described so.

It is to be understood that the above description is intended to be illustrative, and not restrictive. For example, the above-described embodiments may be used in combination with each other. As another example, the above-described flow diagrams include a series of actions which may not be performed in the particular order depicted in the drawings. Rather, the various actions may occur in a different order, or even simultaneously. Many other embodiments will be apparent to those of skill in the art upon reviewing the above description. The scope of the invention should therefore be determined with reference to the appended claims, along with the full scope of equivalents to which such claims are entitled.

What is claimed is:

1. A process for automatically certifying royalty and license fees in the music industry, comprising:
obtaining nonstandardized exploitation data associated with a plurality of media items from a first plurality of data sources during a predetermined period of time, wherein the exploitation data is provided in a plurality of formats;
applying a standardization schema to the nonstandardized exploitation data to obtain standardized exploitation data;
obtaining royalty data from a second plurality of data sources, wherein the royalty data comprises royalty parameters associated with one or more entities associated with the plurality of media items; and
determining an entity-specific royalty data for the one or more entities based on the standardized exploitation data and the royalty data.

2. The process of claim 1, further comprising:
presenting the entity-specific royalty data in a user interface;
prompting a user to confirm the entity-specific royalty data; and
in response to receiving a confirmation, providing a digital certification for the entity-specific royalty data.

3. The process of claim 2, wherein determining the entity-specific royalty data for the one or more entities further comprises:
applying a neural architecture that models relationships and potential interactions between data structures associated with the royalty data.

4. The process of claim 3, wherein the neural architecture comprises a plurality of potential simulations and a plurality of confirmed simulations, wherein the plurality of confirmed simulations have previously been confirmed by a user.

5. The process of claim 4, wherein the neural architecture further comprises suppression relationships between node values outcome type.

6. The process of claim 5, further comprising:
determining a subset of the standardized exploitation data that comprises outliers based on the entity-specific royalty data by identifying an unexpected behavior from the model from the application of the neural architecture to the royalty data;
obtain an indication of a modification to the neural architecture to address the unexpected behavior;
modifying the neural architecture based on indication of the modification; and
applying the modified neural architecture to the royalty data.

7. The process of claim 3, further comprising:
receiving an additional sample data set;
applying at least part of the neural architecture to obtain entity-specific royalty data for the additional sample data set, wherein the at least part of the neural architecture provides supplemental royalty information to the sample data set; and
providing sample entity-specific royalty data in the user interface.

8. The process of claim 3, further comprising:
receiving, through a preferred parameter module in a valuation user interface, preferred parameters for valuation, wherein the preferred parameter comprises one or more of an artist, an exploitation source, a record label, a particular media item, a consumption demographic, and a geographic region;
identifying a valuation data set from the standardized exploitation data; and
applying the neural architecture to obtain valuation data for the preferred parameters.

9. A non-transitory computer readable medium comprising computer readable code executable by one or more processors to:
obtain nonstandardized exploitation data associated with a plurality of media items from a first plurality of data sources during a predetermined period of time, wherein the exploitation data is provided in a plurality of formats;
apply a standardization schema to the nonstandardized exploitation data to obtain standardized exploitation data;
obtain royalty data from a second plurality of data sources, wherein the royalty data comprises royalty parameters associated with one or more entities associated with the plurality of media items; and
determine an entity-specific royalty data for the one or more entities based on the standardized exploitation data and the royalty data.

10. The non-transitory computer readable medium of claim 9, further comprising computer readable code to:
present the entity-specific royalty data in a user interface;
prompt a user to confirm the entity-specific royalty data; and
in response to receiving a confirmation, provide a digital certification for the entity-specific royalty data.

11. The non-transitory computer readable medium of claim 10, wherein the computer readable code to determine the entity-specific royalty data for the one or more entities further comprises computer readable code to:
applying a neural architecture that models relationships and potential interactions between data structures associated with the royalty data.

12. The non-transitory computer readable medium of claim 11, wherein the neural architecture comprises a plurality of potential simulations and a plurality of confirmed simulations, wherein the plurality of confirmed simulations have previously been confirmed by a user.

13. The non-transitory computer readable medium of claim 12, wherein the neural architecture further comprises suppression relationships between node values outcome type.

14. The non-transitory computer readable medium of claim 13, further comprising computer readable code to:
determine a subset of the standardized exploitation data that comprises outliers based on the entity-specific royalty data by identifying an unexpected behavior from the model from the application of the neural architecture to the royalty data;
obtain an indication of a modification to the neural architecture to address the unexpected behavior;
modify the neural architecture based on indication of the modification; and
apply the modified neural architecture to the royalty data.

15. The non-transitory computer readable medium of claim 11, further comprising computer readable code to:
receive an additional sample data set;
apply at least part of the neural architecture to obtain entity-specific royalty data for the additional sample data set, wherein the at least part of the neural architecture provides supplemental royalty information to the sample data set; and
provide sample entity-specific royalty data in the user interface.

16. The non-transitory computer readable medium of claim 11, further comprising computer readable code to:
receive, through a preferred parameter module in a valuation user interface, preferred parameters for valuation, wherein the preferred parameter comprises one or more of an artist, an exploitation source, a record label, a particular media item, a consumption demographic, and a geographic region;
identify a valuation data set from the standardized exploitation data; and
apply the neural architecture to obtain valuation data for the preferred parameters.

17. A system for generating royalty data, comprising:
one or more processors; and
one or more computer readable storage media comprising computer readable code executable by the one or more processors to:
obtain nonstandardized exploitation data associated with a plurality of media items from a first plurality of data sources during a predetermined period of time, wherein the exploitation data is provided in a plurality of formats;
apply a standardization schema to the nonstandardized exploitation data to obtain standardized exploitation data;
obtain royalty data from a second plurality of data sources, wherein the royalty data comprises royalty parameters associated with one or more entities associated with the plurality of media items; and
determine an entity-specific royalty data for the one or more entities based on the standardized exploitation data and the royalty data.

18. The system of claim 17, further comprising computer readable code to:
applying a neural architecture that models relationships and potential interactions between data structures associated with the royalty data;
determine a subset of the standardized exploitation data that comprises outliers based on the entity-specific royalty data by identifying an unexpected behavior from the model from the application of the neural architecture to the royalty data;
obtain an indication of a modification to the neural architecture to address the unexpected behavior;
modify the neural architecture based on indication of the modification; and
apply the modified neural architecture to the royalty data.

19. The system of claim 18, further comprising computer readable code to:
receive an additional sample data set;
apply at least part of the neural architecture to obtain entity-specific royalty data for the additional sample data set, wherein the at least part of the neural architecture provides supplemental royalty information to the sample data set; and
provide sample entity-specific royalty data in a user interface.

20. The system of claim 17, further comprising computer readable code to:
receive, through a preferred parameter module in a valuation user interface, preferred parameters for valuation, wherein the preferred parameter comprises one or more of an artist, an exploitation source, a record label, a particular media item, a consumption demographic, and a geographic region;
identify a valuation data set from the standardized exploitation data; and
apply the neural architecture to obtain valuation data for the preferred parameters.
